(19) United States
(12) Patent Application Publication
(10) Pub. No.: US 2019/0392370 A1
(43) Pub. Date: Dec. 26, 2019

(54) MOBILE SMART LOCKER VEHICLES

(71) Applicant: SMIOTA, INC., PLEASANTON, CA (US)

(72) Inventors: MANJUNATHA KASHI, San Jose, CA (US); JYOTHI KASHI, San Jose, CA (US); KAILASNATH DORNADULA, Fremont, CA (US)

(21) Appl. No.: 16/560,935

(22) Filed: Sep. 4, 2019

Related U.S. Application Data
(63) Continuation-in-part of application No. 15/092,585, filed on Apr. 6, 2016.
(60) Provisional application No. 62/727,334, filed on Sep. 5, 2018.

(51) Int. Cl. G06Q 10/08; G07F 17/12; B64C 39/02; G07C 9/00; G05D 1/02

(52) U.S. Cl. CPC G06Q 10/08; G07F 17/12; B64C 39/024; B64C 2201/128; G05D 1/0212; G05D 2201/0213; G07C 9/00912

(57) ABSTRACT

Disclosed herein are smart locker vehicle devices and systems and methods for operating smart locker vehicle devices, and interacting with smart locker vehicle devices. In an embodiment, a system is disclosed that comprises a memory that stores computer executable components and a processor that executes the computer executable components stored in the memory, wherein the computer executable components comprise a transmission component and a locking component. In an aspect, a transmission component transmits data representing a code or identity authentication information to a set of storage compartments electrically coupled to a vehicle. In another aspect, a locking component is configured to unlock or lock one or more door associated with the set of storage compartments based on the transmitted data.

### CROSS-REFERENCE TO RELATED APPLICATION

This application claims priority to U.S. Patent Application No. 62,727,334 titled, “Mobile Smart Lockers”, and filed on Sep. 5, 2018. This application also claims priority to U.S. patent application Ser. No. 15,092,585 titled, “Devices, Systems, and Methods for Storing Items”, and filed on Apr. 6, 2016, which claims priority to U.S. Patent Application No. 62,146,187 titled, “Smart Mailbox System” and filed on Apr. 10, 2015. The entirety of the disclosures of the aforementioned applications are considered part of, and is incorporated by reference in, the disclosure of this application.

### BACKGROUND

Given the rise of e-commerce applications and the increased transactions of goods and services in the economy, there has been an increase in the quantity of deliveries that occur. For instance, most consumers shop online and order products for shipment directly to their homes on a frequent basis (e.g., daily, weekly, monthly, etc.). However, there are many problems with current delivery logistic mechanisms. Packages often take time (e.g., days) to receive and outbound packages need be dropped off at drop box locations or provided to delivery personnel at the unspecified time period they arrive at a sender's home. Furthermore, shipment services are typically offered within specified business hours (e.g., from 9 a.m.-5 p.m.). The current system of package delivery and pickup is fraught with inefficiencies, time delays, inconveniences to consumers, and often result in a poor user experience. All such problems require solutions or technologies to overcome such issues.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein are systems, devices, apparatuses, computer program products and/or computer-implemented methods that employ system components to facilitate a transmission of data, instructions, and information between a first device and a second device to provide or deny access of the first device to storage items.

According to an embodiment, a system is provided. The system comprises a processor that executes computer executable components stored in memory. The computer executable components comprise a memory that stores computer executable components and a processor that executes the computer executable components stored in the memory, wherein the computer executable components comprise a transmission component that transmits data representing a code or identity authentication information to a set of storage compartments electrically coupled to a vehicle. In another aspect, the system includes a locking component configured to unlock or lock one or more door associated with the set of storage compartments based on the transmitted data.

According to another embodiment, a computer-implemented method is provided. The computer-implemented method can comprise transmitting, by a system comprising a processor, transmission data representing a code or identity authentication information to a set of storage compartments electrically coupled to a vehicle. The computer-implemented method can also comprise unlocking, by the system, one or more door associated with the set of storage compartments based on the transmitted data.

[symbol]

### BRIEF DESCRIPTION OF THE DRAWINGS

FIG. 1 illustrates a block diagram of an example, non-limiting central control system corresponding to a smart locker vehicle, in accordance with one or more embodiments described herein.

FIG. 2 illustrates a flow diagram of an example, non-limiting computer-implemented method that can facilitate storing items within at least one locker compartment of a smart locker vehicle in accordance with one or more embodiments described herein.

FIG. 3 illustrates a flow diagram of an example, non-limiting computer-implemented method that can facilitate storing items within at least one locker compartment of a smart locker vehicle in accordance with one or more embodiments described herein.

FIG. 4 illustrates a flow diagram of an example, non-limiting computer-implemented method that can facilitate storing items within at least one locker compartment of a smart locker vehicle in accordance with one or more embodiments described herein.

FIG. 5 illustrates a block diagram of an example, non-limiting operating environment in which one or more embodiments described herein can be facilitated.

FIG. 6 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In an aspect, disclosed herein are devices, systems and methods comprising digital smart lockers electrically coupled to vehicles for use in facilitating the transportation, receipt, and delivery of packages. In an aspect, such customized vehicles can be used to solve the last mile problem associated with transporting goods from a source location to a final destination such as delivering a package to a user. In an aspect, several stakeholders can utilize the vehicle electrically coupled to the smart locker devices such as delivery organizations, consumers sending packages and/or consumers receiving packages. In an instance, the vehicles can travel predetermined routes or preferred routes or customized routes and consumers (e.g., user seeking to send or receive an item via vehicle storage lockers) can utilize an application executing on a user device to identify the location of a relevant smart locker vehicle. Furthermore, the user device can transmit data (e.g, location data, request data, unlock/lock data, authentication data, etc.) to the smart locker vehicle (e.g., via a network, server device(s), etc.) or a platform (e.g., cloud platform) accessible to the smart locker vehicle.

As such, user device(s), via an application executing on the user device(s), can transmit request data to platform device(s) (e.g., server device(s), cloud network, etc.) where the request represents a request to send packages (via a smart locker vehicle) to a target destination. In an aspect, the user device(s) can transmit delivery data to the platform device(s) and such platform device(s) identifies a set of candidate smart locker vehicles to fulfill the user device(s) delivery request. In an aspect, the platform device(s) can identify one or more smart locker vehicles within range of a user device that transmits a request for a smart locker vehicle.

In another aspect, one or more smart locker vehicle can alter its route or direct its route to interface with a user device requesting to pick-up or drop-off a package associated with the submitted request data. Furthermore, smart locker vehicles can deliver packages to various user devices based on a delivery schedule and route corresponding with users requesting to drop-off or pick-up packages and the platform can identify smart locker vehicle delivery routes near such user devices, so a consumer can drop off a package into a locker unit within a smart locker vehicle without disturbing the smart locker vehicle route. Accordingly, the smart locker vehicles can operate at all hours, not simply within a 9:00 am to 5:00 pm time frame.

In an aspect, a smart locker vehicle can comprise a vehicle such as a car, van, truck, boat or other thing used for transporting people or goods on land, water or through the air. The vehicle can be configured to include a set of smart lockers within a body of the vehicle. In an aspect, the smart lockers embedded within the vehicles can include features such as smart locker compartments that include hardware, software, and physical structures capable of storing items such as packages (e.g., groceries, food, mail, packages, medicines, laundry, tobacco, alcohol, etc.); secure storage areas to access and items for delivery and drop-off; control mechanisms to interface with the smart lockers embedded within the vehicle; network resources to connect several devices in the smart locker vehicle network; a memory that stores executable components; a receptacle component capable of receiving a set of packages, accessible by a set of doors; refrigeration compartments; heating compartments; compartments capable of adjusting dimensions (e.g., expanding and/or retracting); unlocking capabilities; locking capabilities; temperature controlling capabilities; sensor detection capabilities (e.g., equipment status sensors, weather condition sensors, humidity sensors, motion sensors, heat sensors, light sensors, etc.); landing platforms configured to receive a drone for landing; swivel capabilities; monitoring capabilities; scheduling capabilities; permission capabilities; authentication capabilities; identification capabilities; weight detection capabilities; and other such features of the smart lockers configured within the vehicle.

Furthermore, in an aspect, user devices can interact with the smart locker vehicles in a customized manner. For instance, each user device can receive identification data from a central control system configured to transmit identification data to the user device based on receipt of a request from such user device to access a locker compartment. In an aspect, the user device receives identification data corresponding to a locker compartment within a respective smart locker vehicle. Furthermore, the identification data can represent an identification code configured to open a smart locker compartment door upon input (e.g., data transmission of code) of such code to the smart locker vehicle. In an aspect, the user device can trigger (e.g., using an application executing on the mobile device) a transmission of the identification code to the central control system, which in turn transmits a request to unlock or lock a door providing access to a respective locker compartment within the smart locker vehicle.

In an aspect, the unlocked locker compartment facilitates the user to drop-off or pick-up a package or item to store or that was stored in the respective locker compartment of the smart locker vehicle. Furthermore, the smart locker vehicle can transport any of several types of materials including clothing (e.g., dry cleaning), food (e.g., groceries), medicines (e.g., prescription medicines), and other such items in a convenient and easy to use manner. In another aspect, a the central control system can determine routes for the smart locker vehicle to travel based on a range of travel factors including location of item pick-up request, location of item drop-off request, nature of transport request, proximity of locations of other pick-up and drop-of requests, traffic congestion conditions, quality ratings of user devices generating such requests, a state of the smart locker vehicle (e.g., preliminary state, travelling state, final leg state, etc.), and other such factors. As such, the central control system can determine target locations for each smart locker vehicle to travel. In an aspect, the central control system can plan a route based on customized requirement criteria such as smart locker vehicle capability, type of smart locker vehicle (e.g., autonomous vs. person-manned vehicle), congestion of various route segments, route distance, route time, safety criteria, route optimization criteria, and other such planning criteria.

Furthermore, in an aspect, a user device corresponding with a third-party user (e.g., courier organization) can contribute in total or in part to the determination of routes for smart locker vehicles to travel based on user demand to drop-off and/or pickup packages and other such factors. As such, in an instance, the control system can communicate with a range of applications executing on user devices such as a service application for a customer user device, a partner application for vendor or third-party partner user devices (e.g., couriers), an administrative application for enterprise client user devices, and other such applications. As a non-limiting example, the applications can include or use an application programming interface (API), such as an externally facing API, to transmit data to respective user device interfaces. Furthermore, the central control system can communicate with the user device facing API's to provide access to system features and communicate via secure access channels over a smart locker vehicle network.

In another non-limiting embodiment, a smart locker vehicle can comprise smart lockers with a range of capabilities such as storage sensors, heating units, cooling units (e.g., refrigerators), drone loading and drop off stations, and other such features to facilitate the transport of various package types and allow for the drop off and pickup in different manners of various items. In yet another non-limiting embodiment, the smart locker vehicles can employ systems and system components that facilitate the operation of the smart locker elements and the transportation of the smart locker vehicle. For instance, the smart locker vehicle can employ system components that when executed by a processor of the smart locker vehicle can transmit data to allow consumers to unlock compartments and/or lock smart locker compartments, detect package sizes, control drones, instruct the vehicle as to routes to travel, adjust temperatures within compartments, and perform other such tasks associated with the vehicle. In another aspect, a consumer can indicate a range of timings (e.g., transmission of timing data to a platform accessible to the smart locker vehicle) suitable for pickup or delivery of a package within a smart locker vehicle. Accordingly, a smart locker vehicle can arrange routes based on consumer needs or volume of demand for transport services.

In another aspect, the smart locker vehicles can be utilized by a variety of users including those within an organization or individuals desiring to independently operate such smart locker vehicles. Accordingly, an application executing on user devices can also schedule drivers of smart locker vehicles to drive such vehicles along defined routes. Furthermore, in an aspect, smart locker vehicles can include autonomous vehicles that utilize autonomous driving technologies to drive based on computer-implemented technologies that don't require a physical user to conduct driving tasks. Furthermore, in an aspect, the smart locker vehicles can be any one or more of a variety of vehicles including automobiles, trucks, boats, drones, motorcycles, trains, and/or other modes of transportation. In an aspect, each mode of transportation can include an integrated smart locker device.

Furthermore, in an aspect, each smart locker vehicle can transmit and receive data from network devices such as user devices (e.g., smart phones), enterprise devices (e.g., servers), and other smart locker vehicles. In an aspect, the data transmitted to and from each smart locker vehicle can represent various sets of information including package label information, user submitted information, destination information, pickup information, storage requirement information, driving route information, and other such information. In an aspect, the smart locker vehicle can be a vehicle empowered by artificial intelligence comprising refrigerated and non-refrigerated storage compartments capable of operating (e.g., locking and/or unlocking) via wireless communication or wired using a code or authenticated identification by an individual or a set of individuals associated with a deposit/retrieval transaction. Furthermore, in an aspect, the vehicle can navigate or drive from location A to location B then to location C, and so on, where each location can represent a point where a user (e.g., an individual or company) can deposit or retrieve a package or parcel using an authentication mechanism.

Furthermore, a user can reserve or secure a locker (e.g., lock) electronically using an application executing on a device (e.g., user device), website application, an application executing on a cloud platform (e.g., server network), and via other such means prior to arriving at a target location to perform a drop-off or pickup of a package. As a non-limiting example, a mother (e.g., user A) located at location Y (e.g., home in city X) can transport home cooked food parcels to her daughter (e.g., user B) located at location Z (e.g., university in city X) at any time of day or night. As such, on a particular day user A cooks a large meal and decides after cooking to send a package of the meal leftovers to user B from location Y to location Z respectively. Accordingly, user A utilizes a first mobile device to transmit reservation data to a smart locker vehicle (e.g., or a server communication system connected to smart locker vehicle) and the smart locker vehicle transmits booking confirmation data to the first mobile device.

Furthermore, the smart locker vehicle can transmit pickup data to a second mobile device owned by user B. As such, user B via second mobile device can identify that a package will be delivered via the autonomous vehicle and can transmit schedule data representing time and place for picking up the package from the smart locker vehicle. In another aspect, user A can decide to also send a dress to user B with the food parcel and quickly transmits reservation change data to the autonomous vehicle to change the reservation to a larger storage compartment on the smart locker vehicle. In an aspect, the autonomous vehicle can transmit access code data to user B in order for user B to unlock and access the correct compartment on the smart locker vehicle. Furthermore, user B uses second user device transmits reservation data to the smart locker vehicle in order to reserve a compartment on the smart locker vehicle in order to send a package of dirty clothes for laundering to user A at location Y.

As such, the smart locker vehicle can be operated by a system comprising a processor and can communicate with user device via mobile applications executing on such mobile devices. Furthermore, the system components can include platform components that allow enterprises, individuals and smart locker vehicles to communicate with one another and coordinate procurement of services, receipt of services and payment or receipt of payment for services.

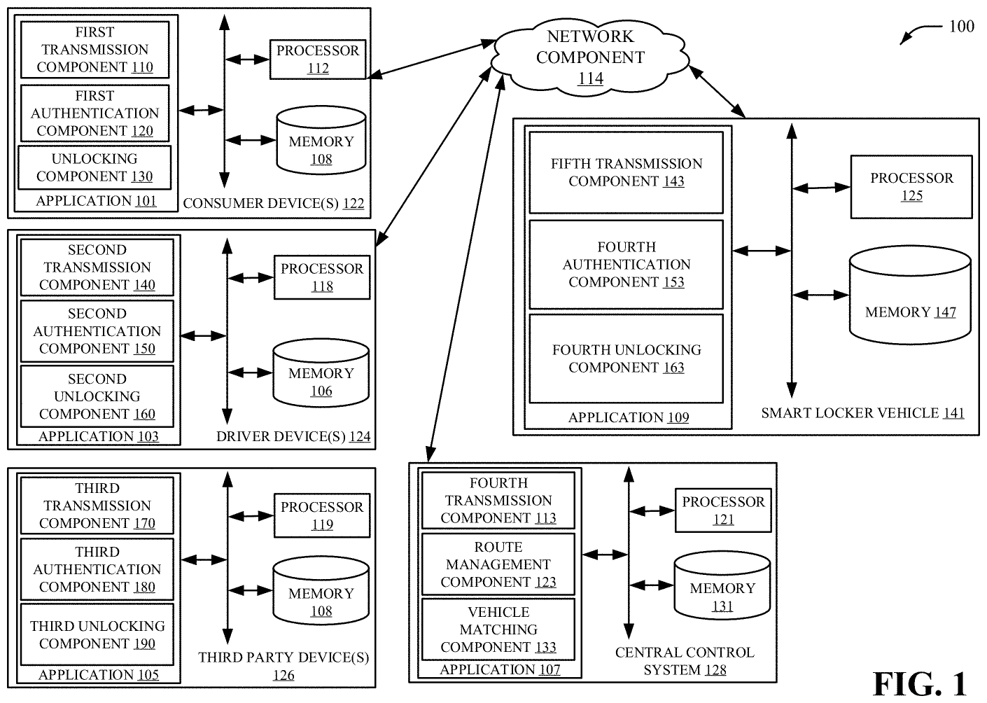

Turning now to FIG. 1, illustrated is a block diagram of an example, non-limiting smart locker vehicle control system 100 corresponding to a smart locker vehicle, in accordance with one or more embodiments described herein. In an aspect, disclosed are consumer device(s) 122, driver device(s) 124, central control system 128, smart locker vehicle 141, and network 114. In an aspect, respective devices can be coupled to one or more processor (e.g., processor 112, processor 118, processor 119, processor 121, etc.) that can execute computer executable components and/or computer instructions stored in one or more memory (e.g., memory 108, memory 106, memory 145, memory 131, memory 147, etc.). In an aspect, one or more processor can execute the computer executable components and/or computer instructions stored in one or more memory. In an aspect, one or more of the components of system 100 can be electrically and/or communicatively coupled to one or more devices (e.g., consumer device(s) 122, driver device(s) 124, third party device(s) 126, central control system 128, smart locker vehicle 141) of system 100 or other embodiments to perform one or more functions described herein.

In an aspect, consumer device(s) 122 can comprise application 101 configured to execute first transmission component 110, first authentication component 120, and/or unlocking component 130. In an aspect the application can be provided by the network system installed on a smartphone and capable of submitting (e.g., via first transmission component 110) service requests to a central control system 128 (e.g., a network control system). In an aspect, the service requests can include a request to pick up or drop off a package or item in a storage locker of the smart locker vehicle. In an aspect, each of consumer device(s) 122, driver device(s) 124, third party device(s) 126, and smart locker vehicle 141 can transmit and/or receive data via first transmission component 110, second transmission component 140, third transmission component 170, fourth transmission component 113, and fifth transmission component 143 respectively.

In another aspect, consumer device(s) 122 can comprise application 101 configured to execute first transmission component 110, first authentication component 120, and/or unlocking component 130. In an aspect the application 101, can be executed by the consumer device 122 (e.g., smartphone) and capable of being authenticated by first authentication component 120. In an aspect, the central control system 128 can authenticate respective devices (and its users) for interaction with system 100. For instance, each device that requests to transmit data or execute an operation corresponding with smart locker vehicles can include an account or user information provided by each user device (e.g., after a login to each respective application). Furthermore, the central control system 128 can authenticate the users before enabling the users to request a service. In an instance, service requests can include a request to pick up or drop off a package or item in a storage locker of the smart locker vehicle. In an aspect, each of consumer device(s) 122, driver device(s) 124, third party device(s) 126, and smart locker vehicle 141 can transmit and/or receive data authentication data via first authentication component 120, second authentication component 150, third authentication component 180, and/or fourth authentication component 153. In yet another aspect, each device application (e.g., application 101, application 103, application 105, application 107, application 109) can execute or facilitate the execution of a locking operation or unlocking operation of respective smart locker compartments within a smart locker vehicle using unlocking components (e.g., unlocking component 130, second unlocking component 160, third unlocking component 190, fourth unlocking component 192).

In an aspect, driver device(s) 124 can communicate with a map application and/or route application executed by central control system 128 to service a pick-up and/or drop off request. Furthermore, the driver device(s) 124 can continue to communicate with central control system 128 during several time intervals (e.g., after a first route is satisfied, a second route can be determined to the next stop). In another aspect, driver device(s) 124 can request scheduling data, payment data, location tracking of delivery, curated deals and promotions from central controls system 128. In another aspect, central control system 128 can execute application 107 that can execute a range of operations such as unlocking locker compartments of smart locker vehicle 141 based on satisfaction of authentication requirements and receipt of unlocking instructions from respective consumer device(s) 122. Furthermore, in an aspect, vehicle matching component 133 can match a consumer device 122 to a respective smart locker vehicle 141 based on time factors, location factors, route factors, and other such variables.

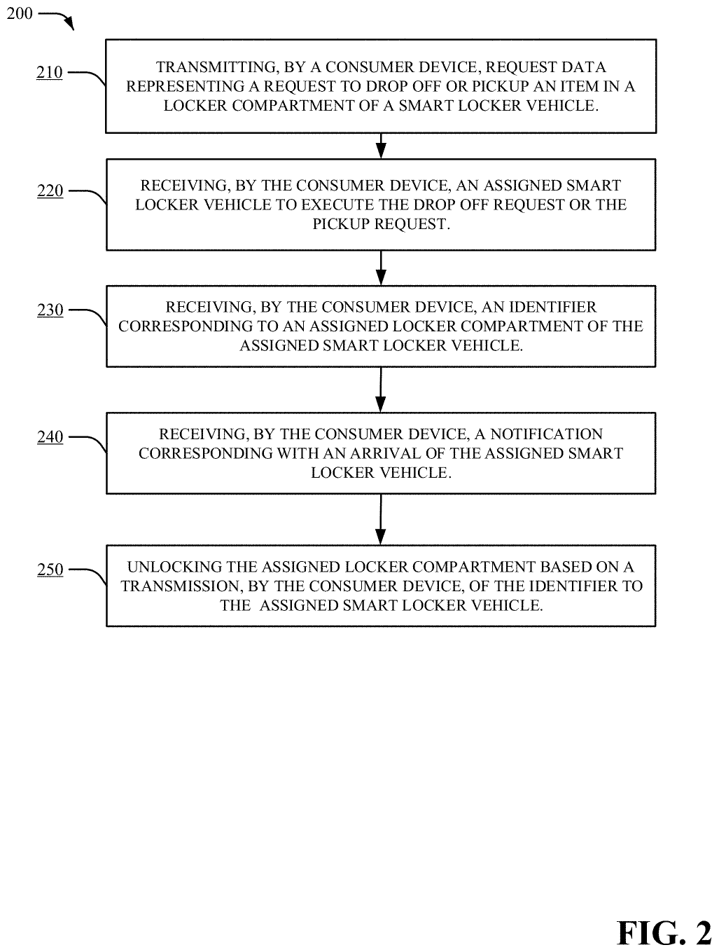

Turning now to FIG. 2, illustrated is a flow diagram of an example, non-limiting computer-implemented method 200 that can facilitate storing items within at least one locker compartment of a smart locker vehicle in accordance with one or more embodiments described herein. Repetitive description of like elements employed in other embodiments described herein is omitted for sake of brevity. At reference numeral 210, request data is transmitted (e.g., first transmission data 110), by a consumer device (e.g., using consumer device(s) 122) to a locker compartment of a smart locker vehicle (e.g., using smart locker vehicle 141), where the request data represents a request to drop off or pickup an item. At reference numeral 220, the consumer device can receive an assigned smart locker vehicle to execute the drop off request or the pickup request. At reference numeral 230, a consumer device can receive an identifier corresponding to an assigned locker compartment of the assigned smart locker vehicle. At reference numeral 240, the consumer device can receive a notification corresponding with an arrival of the assigned smart locker vehicle. At reference numeral 250, the consumer device can unlock the assigned locker compartment based on a transmission of identifier data to an assigned smart locker vehicle.

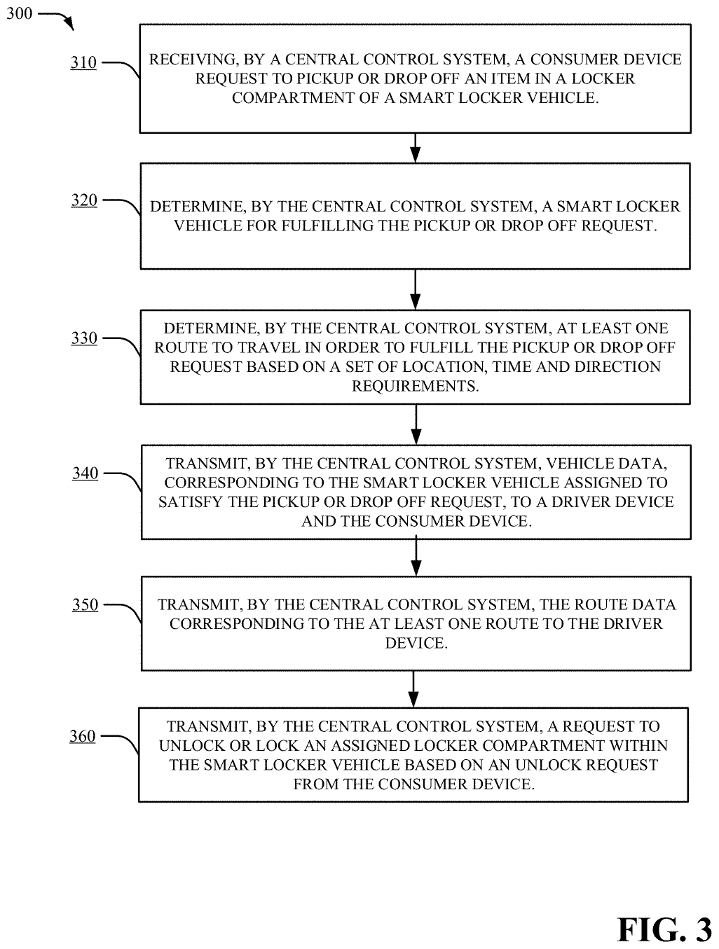

Turning now to FIG. 3, illustrated is a flow diagram of an example, non-limiting computer-implemented method 300 that can facilitate storing items within at least one locker compartment of a smart locker vehicle in accordance with one or more embodiments described herein. Repetitive description of like elements employed in other embodiments described herein is omitted for sake of brevity. At reference numeral 310, a central control system (e.g., central control system 128) can receive a consumer device request to pick-up or drop off an item in a locker compartment of a smart locker vehicle. At reference numeral 320, the central control system determines a smart locker vehicle for fulfilling the pickup or drop off request. At reference numeral 330, the central control system determines at least one route to travel in order to fulfill the pickup or drop off request based on a set of location, time and direction requirements. At reference numeral 340, the central control system transmits vehicle data, corresponding to the smart locker vehicle assigned to satisfy the pickup or drop off request, to a driver device and the consumer device. At reference numeral 350, the central control system transmits route data corresponding to the at least one route to the driver device. At reference numeral 360, the central control system transmits a request to unlock or lock an assigned locker compartment within the smart locker vehicle based on an unlock request from the consumer device.

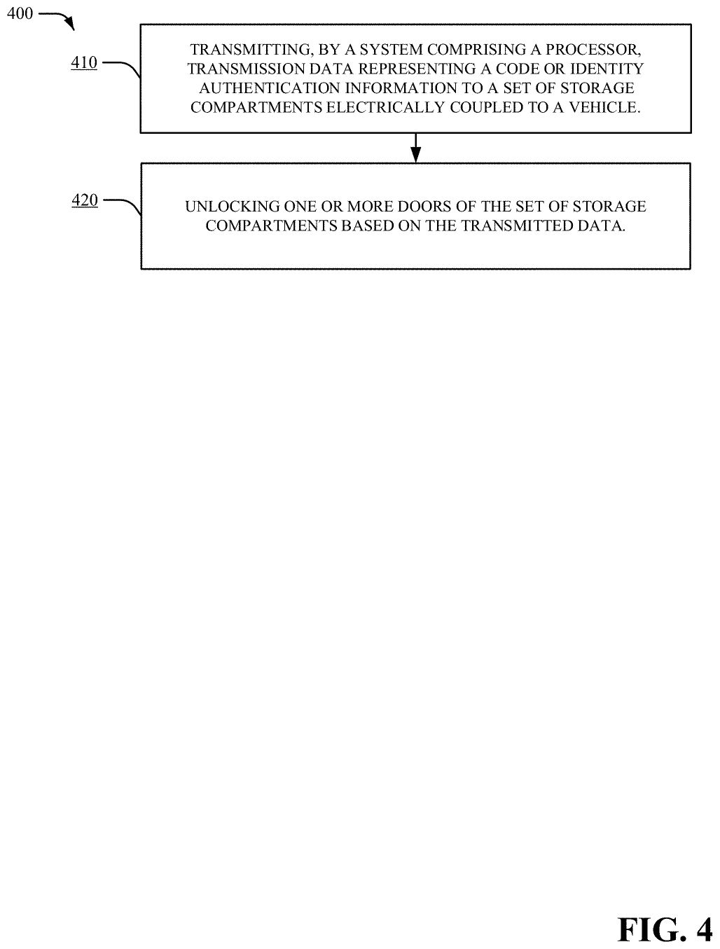

FIG. 4, illustrated is a flow diagram of an example, non-limiting computer-implemented method 400 that can facilitate an unlocking of a compartment of a smart locker vehicle device. Repetitive description of like elements employed in other embodiments described herein is omitted for sake of brevity. At reference numeral 410, transmission data is transmitted, by a system comprising a processor, representing a code or identity authentication information to a set of storage compartments electrically coupled to a vehicle. At reference numeral 420, one or more door associated with the set of storage compartments is unlocked based on the transmitted data.

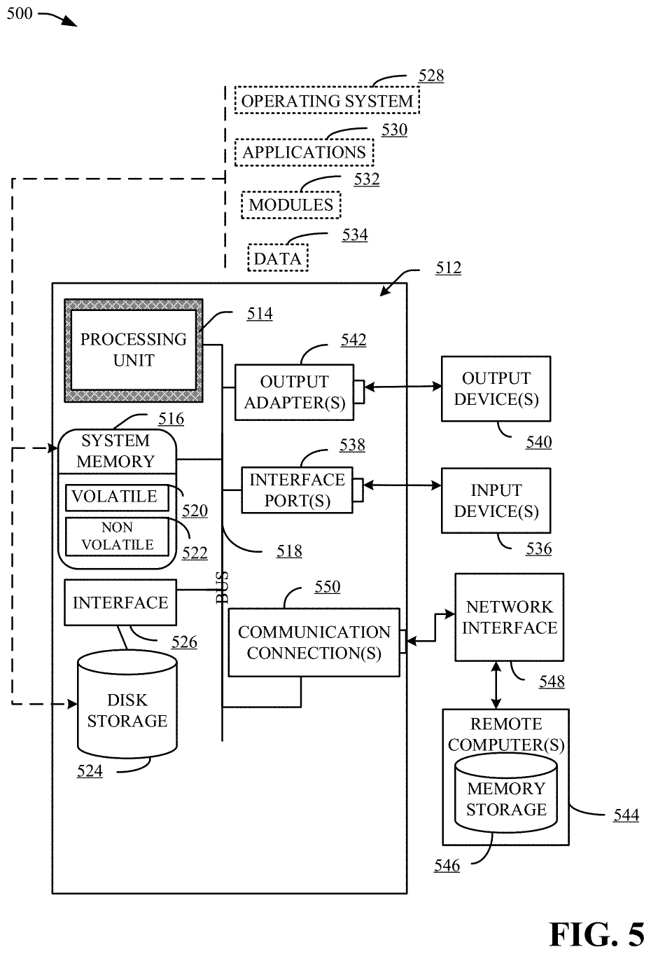

In order to provide a context for the various aspects of the disclosed subject matter, FIG. 5 as well as the following discussion is intended to provide a general description of a suitable environment in which the various aspects of the disclosed subject matter can be implemented. FIG. illustrates a block diagram of an example, non-limiting operating environment in which one or more embodiments described herein can be facilitated. With reference to FIG. 5, a suitable operating environment 500 for implementing various aspects of this disclosure can also include a computer 512. The computer 512 can also include a processing unit 514, a system memory 516, and a system bus 518. The system bus 518 couples system components including, but not limited to, the system memory 516 to the processing unit 514. The processing unit 514 can be any of various available processors. Dual microprocessors and other multiprocessor architectures also can be employed as the processing unit 514. The system bus 518 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 516 can also include volatile memory 520 and nonvolatile memory 522. The basic input/output system (BIOS), containing the basic routines to transfer information between elements within the computer 512, such as during start-up, is stored in nonvolatile memory 522. By way of illustration, and not limitation, nonvolatile memory 522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 512 can also include removable/non-removable, volatile/non-volatile computer storage media. FIG. 5 illustrates, for example, a disk storage 524. Disk storage 524 can also include, but is not limited to, devices like a magnetic disk drive, floppy disk drive, tape drive, Jaz drive, Zip drive, LS-100 drive, flash memory card, or memory stick. The disk storage 524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 524 to the system bus 518, a removable or non-removable interface is typically used, such as interface 526. FIG. 5 also depicts software that acts as an intermediary between users and the basic computer resources described in the suitable operating environment 500. Such software can also include, for example, an operating system 528. Operating system 528, which can be stored on disk storage 524, acts to control and allocate resources of the computer 512.

System applications 530 take advantage of the management of resources by operating system 528 through program modules 532 and program data 534, e.g., stored either in system memory 516 or on disk storage 524. It is to be appreciated that this disclosure can be implemented with various operating systems or combinations of operating systems. A user enters commands or information into the computer 512 through input device(s) 536. Input devices 536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 514 through the system bus 518 via interface port(s) 538. Interface port(s) 538 include, for example, a serial port, a parallel port, a game port, and a universal serial bus (USB). Output device(s) 540 use some of the same type of ports as input device(s) 536. Thus, for example, a USB port can be used to provide input to computer 512, and to output information from computer 512 to an output device 540. Output adapter 1242 is provided to illustrate that there is some output device 540 like monitors, speakers, and printers, among other such output device 540, which require special adapters. The output adapters 542 include, by way of illustration and not limitation, video and sound cards that provide a means of connection between the output device 540 and the system bus 518. It should be noted that other devices and/or systems of devices provide both input and output capabilities such as remote computer(s) 544.

Computer 512 can operate in a networked environment using logical connections to one or more remote computers, such as remote computer(s) 544. The remote computer(s) 544 can be a computer, a server, a router, a network PC, a workstation, a microprocessor based appliance, a peer device or other common network node and the like, and typically can also include many or all of the elements described relative to computer 512. For purposes of brevity, only a memory storage device 546 is illustrated with remote computer(s) 544. Remote computer(s) 544 is logically connected to computer 512 through a network interface 548 and then physically connected via communication connection 550. Network interface 548 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 550 refers to the hardware/software employed to connect the network interface 548 to the system bus 518. While communication connection 550 is shown for illustrative clarity inside computer 512, it can also be external to computer 512. The hardware/software for connection to the network interface 548 can also include, for exemplary purposes only, internal and external technologies such as, modems including regular telephone grade modems, cable modems and DSL modems, ISDN adapters, and Ethernet cards.

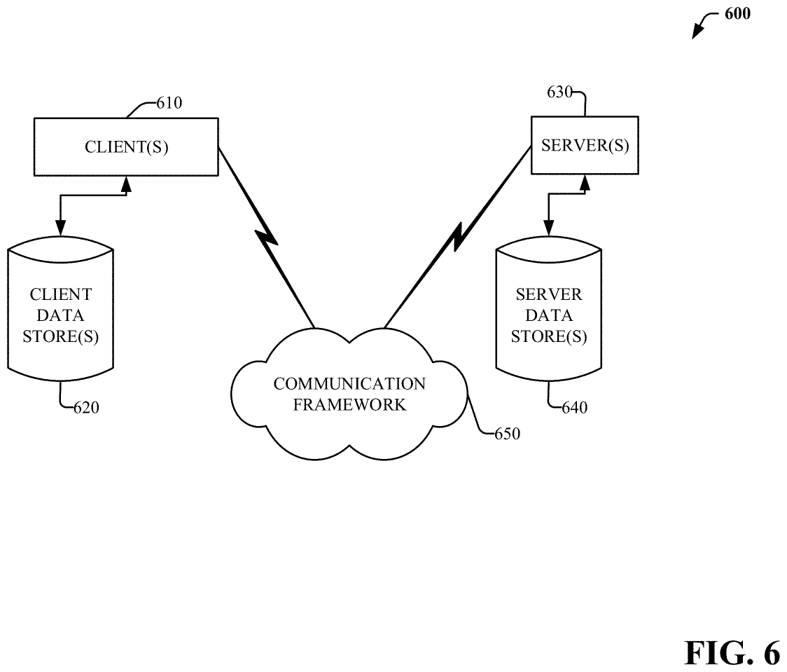

Referring now to FIG. 6, there is illustrated a schematic block diagram of a computing environment 600 in accordance with this disclosure. The system 600 includes one or more client(s) 602 (e.g., laptops, smart phones, PDAs, media players, computers, portable electronic devices, tablets, and the like). The client(s) 602 can be hardware and/or software (e.g., threads, processes, computing devices). The system 600 also includes one or more server(s) 604. The server(s) 604 can also be hardware or hardware in combination with software (e.g., threads, processes, computing devices). The servers 604 can house threads to perform transformations by employing aspects of this disclosure, for example. One possible communication between a client 602 and a server 604 can be in the form of a data packet transmitted between two or more computer processes wherein the data packet may include video data. The data packet can include a metadata, e.g., associated contextual information, for example. The system 600 includes a communication framework 606 (e.g., a global communication network such as the Internet, or mobile network(s)) that can be employed to facilitate communications between the client(s) 602 and the server(s) 604.

Communications can be facilitated via a wired (including optical fiber) and/or wireless technology. The client(s) 602 include or are operatively connected to one or more client data store(s) 608 that can be employed to store information local to the client(s) 602 (e.g., associated contextual information). Similarly, the server(s) 604 are operatively include or are operatively connected to one or more server data store(s) 610 that can be employed to store information local to the servers 604. In one embodiment, a client 602 can transfer an encoded file, in accordance with the disclosed subject matter, to server 604. Server 604 can store the file, decode the file, or transmit the file to another client 602. It is to be appreciated, that a client 602 can also transfer uncompressed file to a server 604 and server 604 can compress the file in accordance with the disclosed subject matter. Likewise, server 604 can encode video information and transmit the information via communication framework 606 to one or more clients 602.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor that executes the computer executable components stored in the memory, wherein the computer executable components comprise:
a transmission component that transmits data representing a code or identity authentication information to a set of storage compartments electrically coupled to a vehicle; and
a locking component configured to unlock or lock one or more door associated with the set of storage compartments based on the transmitted data.

2. The system of claim 1, wherein the vehicle is an autonomous car, autonomous drone, or autonomous truck.

3. The system of claim 1, further comprising a reservation component that transmits reservation data representing a rental of the one or more door.

4. The system of claim 3, further comprising a navigation component that provides guidance data representing a route for the vehicle to travel based on the reservation data.

5. A computer-implemented method, comprising:
transmitting, by a consumer device comprising one or more processor, request data representing a request to drop off or pickup an item in a locker compartment of a smart locker vehicle;
receiving, by the consumer device, an assigned smart locker vehicle to execute the drop off request or the pickup request;
receiving, by the consumer device, an identifier corresponding to an assigned locker compartment of the assigned smart locker vehicle;
receiving, by the consumer device, a notification corresponding with an arrival of the assigned smart locker vehicle; and
unlocking the assigned locker compartment based on a transmission, by the consumer device, of the identifier to the assigned smart locker vehicle.

6. A computer-implemented method, comprising:
receiving, by a central control system, a consumer device request to pickup or drop off an item in a locker compartment of a smart locker vehicle;
determining, by the central control system a smart locker vehicle for fulfilling the pickup or drop off request;
determining, by the central control system, at least one route to travel in order to fulfill the pickup or drop off request based on a set of location, time and direction requirements;
transmitting, by the central control system, vehicle data corresponding to the smart locker vehicle assigned to satisfy the pickup or drop off request, to a driver device and the consumer device;
transmitting, by the central control system, the route data corresponding to the at least one route to the driver device; and
transmitting, by the central control system, a request to unlock or lock an assigned locker compartment within the smart locker vehicle based on an unlock request from the consumer device.

7. The computer-implemented method of claim 6, further comprising, unlocking, by the smart locker vehicle the assigned locker compartment based on receipt of the request to unlock the assigned locker compartment.

8. The computer-implemented method of claim 6, further comprising transmitting, by the central control system, authentication data corresponding to the consumer device to the smart locker vehicle.

9. The computer-implemented method of claim 6, further comprising transmitting, by the central control system, route instructions to the smart locker vehicle based on a pickup and drop off schedule.

10. The computer-implemented method of claim 9, further comprising adjusting, by the central control system, one or more route configuration based on an adjustment to the pickup and drop off schedule.
